(19) United States
(12) Patent Application Publication
(10) Pub. No.: US 2004/0004991 A1
(43) Pub. Date: Jan. 8, 2004

(54) Machine case alarming mark

(76) Inventor: Luke Wu, Ilan (TW)

Correspondence Address: BIRCH STEWART KOLASCH & BIRCH, PO BOX 747, FALLS CHURCH, VA, 22040-0747, US

(21) Appl. No.: 10/377,735

(22) Filed: Mar. 4, 2003

(30) Foreign Application Priority Data
Jul. 2, 2002 (TW) 091210013

(51) Int. Cl. G01K 11/00

(52) U.S. Cl. 374/162; 40/299.01

(57) ABSTRACT

A machine case alarming mark has a plurality of color states that are alterable according to the level of thermal energy on the machine case to achieve an alarm effect. The mark is attached to the exterior of a computer casing and is visibly noticeable from the outside. The mark may be an irregular geometric pattern or a logo, and may be formed by a coating material or sticker.

### FIELD OF THE INVENTION

The invention relates to a machine case alarming mark and particularly an alarming mark that changes states according to alteration of temperature.

### BACKGROUND OF THE INVENTION

With the rapid advance of technology, computer functions are quickly expanding. Computer processing speed also has to increase to meet the growing demands and workloads. For instance, CPU processing speed has increased from MHz just a few years ago to GHz at present. The Intel Pentium 4 series CPU now on the market has an operating frequency reaching 2 GHz.

Increasing speed means that electronic circuitry becomes more complex. When the complex circuitry operates, high-speed electrons generate a greater amount of thermal energy and result in higher temperature of the chips. The thermal energy also produces noises that have a serious impact. High temperature also severely affects the service life of electronic elements. In order to enable the processing chips to function normally, a common approach is to add a radiator to transfer the heat away, otherwise the chips will be easily damaged. Hence the present computer systems generally are equipped with a large radiator and an air fan to resolve the heat dissipation problem.

As heat dissipation has a great impact on system operation, merely employing the radiator to disperse heat from the system is too risky and could result in the system overheating and being damaged. The present temperature detection system reads system temperature through BIOS software when the computer is started. Once the system is started, temperature variation or reading can only be obtained by restarting the system, or through software to detect the chip temperature. However, the software for detecting temperature must be registered and downloaded, and the software location in the server must be searched for. There are also license and charge issues. They are not user-friendly and are not well accepted. In addition, whether reading the temperature through BIOS or temperature detection software, users are informed passively of the system temperature. Many users do not pay attention to whether the system is overheating or not.

All of aforesaid issues indicate that present computer systems do not have a simple alarming mark to inform users of the temperature condition inside the computer systems. It is therefore necessary to develop a simple means to make users aware of the internal temperature of their computer system so that they may temporarily shut down the computer for cooling if necessary to protect the electronic elements in the computer.

### SUMMARY OF THE INVENTION

In view of the aforesaid disadvantages, the object of the invention is to provide a machine case alarming mark that has a plurality of color states. The state of the mark may be changed according to thermal energy on the casing, thereby achieve a warning effect.

The mark is adhered to the exterior of the computer casing and is visibly noticeable. It may be a geometric pattern or a logo, and may be a coating material or a sticker.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a first embodiment of the invention.

FIG. 2 is a schematic view of a second embodiment of the invention.

### DESCRIPTION OF THE PREFERRED EMBODIMENTS

Heat is a form of thermal energy transfer, and can be classified in thermal conduction, radiation and convection. Thermal conduction is the basic form of energy transfer that takes place in a substance or through contact of substances (the substances include gas, liquid or solid). Thermal conductive power is directly proportional to the conductivity and contact area (the greater the contact area, the greater amount of thermal energy transferred), and is inversely proportional to the thickness (or distance). Thermal convection occurs between the surface contact of flowing fluid (gas or liquid) and solid substances, and thermal energy is carried away from the solid surface by the fluid. Thermal radiation transfers heat without any medium (air) and also does not require physical contact. Thermal absorption power and radiation power of the object surface determine heat exchange capability.

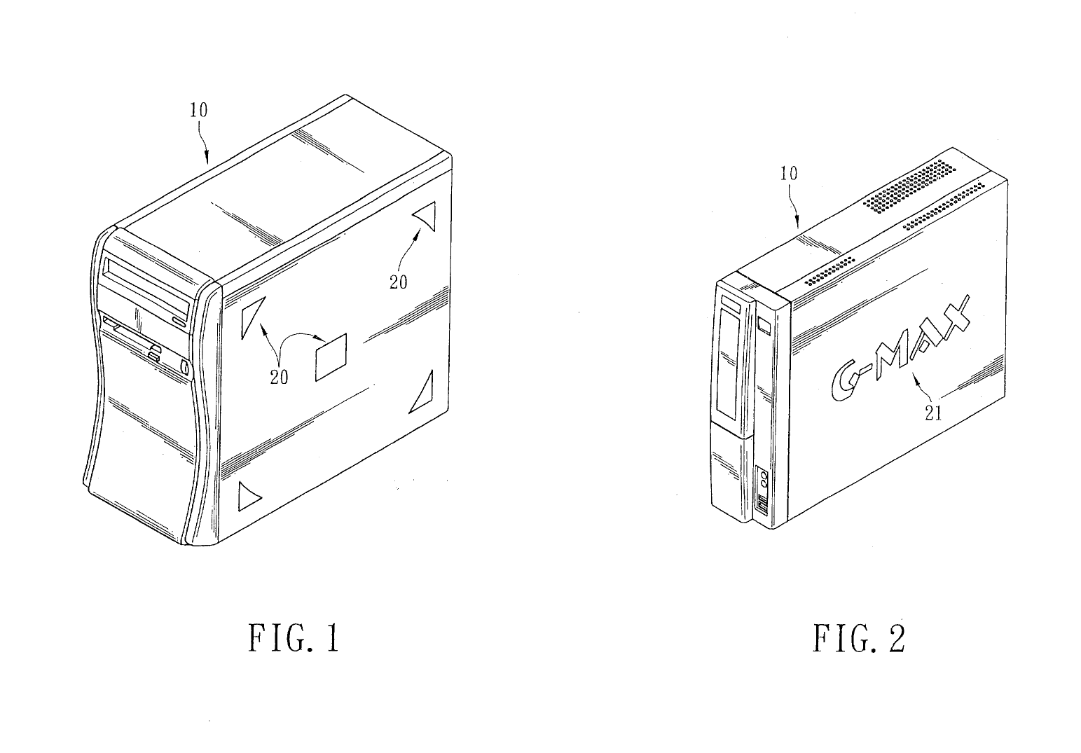

In a computer system, thermal energy generated by various chips during operation may be transferred to the machine casing through thermal radiation and convection, then through a thermal conduction method transferred to a mark sensitive to thermal energy variation on the exterior of the casing that is visible to users. The mark may be an irregular geometric pattern, as an alarm mark 20 attached to the outer surface of a computer casing 10 shown in FIG. 1, or a commercial logo 21 as shown in FIG. 2.

The computer casing is specially designed so that it can transfer heat to the alarm mark 20 with minimal loss of thermal energy. The alarm mark 20 may be made in many forms, and is alterable depending on the level of thermal energy on the computer casing (i.e. thermal energy transferred to the casing). In one embodiment of the invention, the form is the color of the mark. By means of a coating material disclosed in the invention, when the temperature of the casing is A° C., the color state is SA, i.e. the color in normal conditions. When the temperature exceeds B° C., the internal molecular structure is changed and the state is altered to SB.

Hence in normal conditions, the alarm mark 20 is at the state SB. When the chips operate in high speed and generate thermal energy to raise the temperature inside the casing, through thermal conduction, the alarm mark 20 changes its color state to SB. Furthermore, in the event that the temperature of the casing has reached a condition in which computer shutdown is necessary, the mark 20 may be changed to another state SC. Thus users can rely on a visual method without complicated processes to recognize the internal temperature of the computer system. In addition, the mark with changing color states has an aesthetically appealing and amusing effect.

In summary, the machine case alarming mark of the invention has a coating material or sticker attached to the metal casing that can change color at different temperatures. Users can be easily informed if the temperature inside the casing is too high without going through a complicated process. In addition, the changing color state has an aesthetically appealing and amusing effect.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A machine case alarming mark attached to the exterior of a computer casing visible from outside, the mark being characterized in that it has a plurality of color states alterable according to thermal energy on the computer casing to achieve an alarming effect.

2. The machine case alarming mark of claim 1, wherein the mark is selectively an irregular geometric pattern or a logo.

3. The machine case alarming mark of claim 1, wherein the mark is a coating material.

4. The machine case alarming mark of claim 1, wherein the mark is a sticker.

5. A machine case alarming mark, the mark being characterized in that it comprises a selected geometric pattern attaching to the exterior of a computer casing and having a plurality of color states which are alterable according to thermal energy on the computer casing to achieve an alarming effect.

6. The machine case alarming mark of claim 5, wherein the mark is a coating material.

7. The machine case alarming mark of claim 5, wherein the mark is a sticker.

8. A machine case alarming mark comprising a selected coating material formed in a selected geometric pattern for attaching to the exterior of a computer casing visible from outside, the mark being characterized in that it has a plurality of color states which are alterable according to thermal energy on the computer casing to achieve an alarming effect.
